(19) United States
(12) Patent Application Publication
(10) Pub. No.: US 2023/0219572 A1
(43) Pub. Date: Jul. 13, 2023

(54) TRACTION CONTROL SYSTEM USING FEEDFORWARD CONTROL

(71) Applicant: GM Global Technology Operations LLC, Detroit, MI (US)

(72) Inventors: Joonho Lee, Troy, MI (US); Josh Campbell, Royal Oak, MI (US); Danny John Grignion, Belle River (CA); Ryan C. Morris, Farmington Hills, MI (US); Russell T. Capito, Ortonville, MI (US); Mark B. Clark, Milford, MI (US); Jason Seunghwa Rhee, Canton, MI (US)

(21) Appl. No.: 17/575,041

(22) Filed: Jan. 13, 2022

(51) Int. Cl. B60W 30/18; B60W 10/04; B60W 10/18; B60W 50/00

(52) U.S. Cl. CPC B60W 30/18172; B60W 10/04; B60W 10/18; B60W 50/0098; B60W 2540/18; B60W 2520/26; B60W 2710/18; B60W 2050/0026; B60W 2050/0012

(57) ABSTRACT

A system comprises a computer including a processor and a memory. The memory includes instructions such that the processor is programmed to: estimate a slip condition corresponding to at least one vehicle wheel; and generate, via an explicit Nonlinear Model Predictive Control (NMPC) module, control data for operating the at least one vehicle wheel based on the estimated slip condition. The explicit Nonlinear Model Predictive Control (NMPC) module includes a feedforward control module that is configured to generate adjustment data based on the estimated slip condition, wherein the adjustment data modifies the control data.

### INTRODUCTION

The present disclosure relates to using explicit Model Predictive Control (ENMPC) to control vehicles using feedforward control.

Challenges in controlling autonomous vehicles can include modeling uncertainty and stability of closed-loop systems. For example, feedback control only depends on errors between a desired target trajectory and current wheel measurements.

### SUMMARY

A system comprises a computer including a processor and a memory. The memory includes instructions such that the processor is programmed to: estimate a slip condition corresponding to at least one vehicle wheel; and generate, via an explicit Nonlinear Model Predictive Control (NMPC) module, control data for operating the at least one vehicle wheel based on the estimated slip condition. The explicit Nonlinear Model Predictive Control (NMPC) module includes a feedforward control module that is configured to generate adjustment data based on the estimated slip condition, wherein the adjustment data modifies the control data.

In other features, the processor is further programmed to estimate the slip condition based on sensor data.

In other features, the sensor data comprises data indicative of at least one of an axle velocity, a road steering wheel angle, a road steering angular rate, a track corresponding to the at least one vehicle wheel, or a wheelbase corresponding to the at least one vehicle wheel.

In other features, the processor is further programmed to receive the sensor data from at least one vehicle sensor.

In other features, the control data comprises data representing at least one of a constrained brake input command or a propulsion torque command.

In other features, the processor is further programmed to transmit the control data to an actuator to control at least one of a left front wheel brake torque, or a right front wheel brake torque.

In other features, the slip condition represents a particular wheel behavior occurring due to a driving condition.

In other features, the slip condition corresponds to at least one of a long stable period, a stable period, or a short stable period.

In other features, the processor is further programmed to access a lookup table that relates the estimated slip condition to the adjustment data.

In other features, the feedforward control module includes the lookup table.

A method includes estimating a slip condition corresponding to at least one vehicle wheel, and generating, via an explicit Nonlinear Model Predictive Control (NMPC) module, control data for operating the at least one vehicle wheel based on the estimated slip condition. The explicit Nonlinear Model Predictive Control (NMPC) module includes a feedforward control module that is configured to generate adjustment data based on the estimated slip condition, wherein the adjustment data modifies the control data

In other features, the method further includes estimating the slip condition based on sensor data.

In other features, the sensor data comprises data indicative of at least one of an axle velocity, a road steering wheel angle, a road steering angular rate, a track corresponding to the at least one vehicle wheel, or a wheelbase corresponding to the at least one vehicle wheel.

In other features, the method further includes receiving the sensor data from at least one vehicle sensor.

In other features, the control data comprises data representing at least one of a constrained brake input command or a propulsion torque command.

In other features, the method further includes transmitting the control data to an actuator to control at least one of a left front wheel brake torque, or a right front wheel brake torque.

In other features, the slip condition represents a particular wheel behavior occurring due to a driving condition.

In other features, the slip condition corresponds to at least one of a long stable period, a stable period, or a short stable period.

In other features, the method further includes accessing a lookup table that relates the estimated slip condition to the adjustment data.

In other features, the feedforward control module includes the lookup table.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a block diagram of an example system including a vehicle;

FIG. 2 is a block diagram of an example vehicle computer;

FIG. 3 is a block diagram of an example computing device;

and

FIG. 4 is a flow diagram illustrating an example process for generating adjustment data within an explicit Nonlinear Model Predictive Control (NMPC) module via a feedforward control module.

### DETAILED DESCRIPTION

The following description is merely exemplary in nature and is not intended to limit the present disclosure, application, or uses.

Due to modeling uncertainties and potential instability of closed-loop control systems, autonomous operation of vehicles is potentially associated with error or deviation from the planned trajectory. Errors in a system model for an autonomous vehicle result in errors in adhering to a planned trajectory for the autonomous system. As discussed herein, a vehicle can include a feedforward control that complements an explicit Model Predictive Control (ENMPC), which can result in enhanced wheel performance.

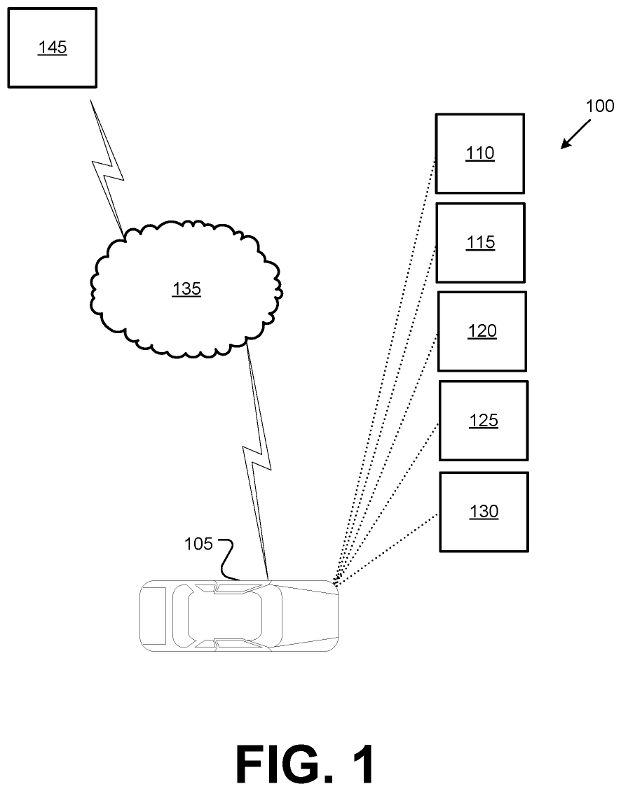

FIG. 1 is a block diagram of an example vehicle system 100. The system 100 includes a vehicle 105, which can comprise a land vehicle such as a car, truck, etc., an aerial vehicle, and/or an aquatic vehicle. The vehicle 105 includes a computer 110, vehicle sensors 115, actuators 120 to actuate various vehicle components 125, and a vehicle communications module 130. Via a network 135, the communications module 130 allows the computer 110 to communicate with a server 145.

The computer 110 may operate a vehicle 105 in an autonomous, a semi-autonomous mode, or a non-autonomous (manual) mode. For purposes of this disclosure, an autonomous mode is defined as one in which each of vehicle 105 propulsion, braking, and steering are controlled by the computer 110; in a semi-autonomous mode the computer 110 controls one or two of vehicles 105 propulsion, braking, and steering; in a non-autonomous mode a human operator controls each of vehicle 105 propulsion, braking, and steering.

The computer 110 may include programming to operate one or more of vehicle 105 brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via the vehicle 105 communications module 130 as described further below, more than one processor, e.g., included in electronic controller units (ECUs) or the like included in the vehicle 105 for monitoring and/or controlling various vehicle components 125, e.g., a powertrain controller, a brake controller, a steering controller, etc. Further, the computer 110 may communicate, via the vehicle 105 communications module 130, with a navigation system that uses the Global Position System (GPS). As an example, the computer 110 may request and receive location data of the vehicle 105. The location data may be in a known form, e.g., geo-coordinates (latitudinal and longitudinal coordinates).

The computer 110 is generally arranged for communications on the vehicle 105 communications module 130 and also with a vehicle 105 internal wired and/or wireless network, e.g., a bus or the like in the vehicle 105 such as a controller area network (CAN) or the like, and/or other wired and/or wireless mechanisms.

Via the vehicle 105 communications network, the computer 110 may transmit messages to various devices in the vehicle 105 and/or receive messages from the various devices, e.g., vehicle sensors 115, actuators 120, vehicle components 125, a human machine interface (HMI), etc. Alternatively or additionally, in cases where the computer 110 actually comprises a plurality of devices, the vehicle 105 communications network may be used for communications between devices represented as the computer 110 in this disclosure. Further, as mentioned below, various controllers and/or vehicle sensors 115 may provide data to the computer 110. The vehicle 105 communications network can include one or more gateway modules that provide interoperability between various networks and devices within the vehicle 105, such as protocol translators, impedance matchers, rate converters, and the like.

Vehicle sensors 115 may include a variety of devices such as are known to provide data to the computer 110. For example, the vehicle sensors 115 may include wheel sensors that measure tire forces. The vehicle sensors 115 may also include Light Detection and Ranging (lidar) sensor(s) 115, etc., disposed on a top of the vehicle 105, behind a vehicle 105 front windshield, around the vehicle 105, etc., that provide relative locations, sizes, and shapes of objects and/or conditions surrounding the vehicle 105. As another example, one or more radar sensors 115 fixed to vehicle 105 bumpers may provide data to provide and range velocity of objects (possibly including second vehicles 106), etc., relative to the location of the vehicle 105. The vehicle sensors 115 may further include camera sensor(s) 115, e.g., front view, side view, rear view, etc., providing images from a field of view inside and/or outside the vehicle 105.

The vehicle 105 actuators 120 are implemented via circuits, chips, motors, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a park assist component, an adaptive cruise control component, an adaptive steering component, a movable seat, an anti-lock braking system component (ABS), a traction control system component (TCS), and/or an electronic stability control system component.

In addition, the computer 110 may be configured for communicating via a vehicle-to-vehicle communication module or interface 130 with devices outside of the vehicle 105, e.g., through a vehicle to vehicle (V2V) or vehicle-to-infrastructure (V2X) wireless communications to another vehicle, to (typically via the network 135) a remote server 145. The module 130 could include one or more mechanisms by which the computer 110 may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the module 130 include cellular, Bluetooth®, IEEE 802.11, dedicated short-range communications (DSRC), and/or wide area networks (WAN), including the Internet, providing data communication services.

The network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, Bluetooth Low Energy (BLE), IEEE 802.11, vehicle-to-vehicle (V2V) such as Dedicated Short-Range Communications (DSRC), etc.), local area networks (LAN) and/or wide area networks (WAN), including the Internet, providing data communication services.

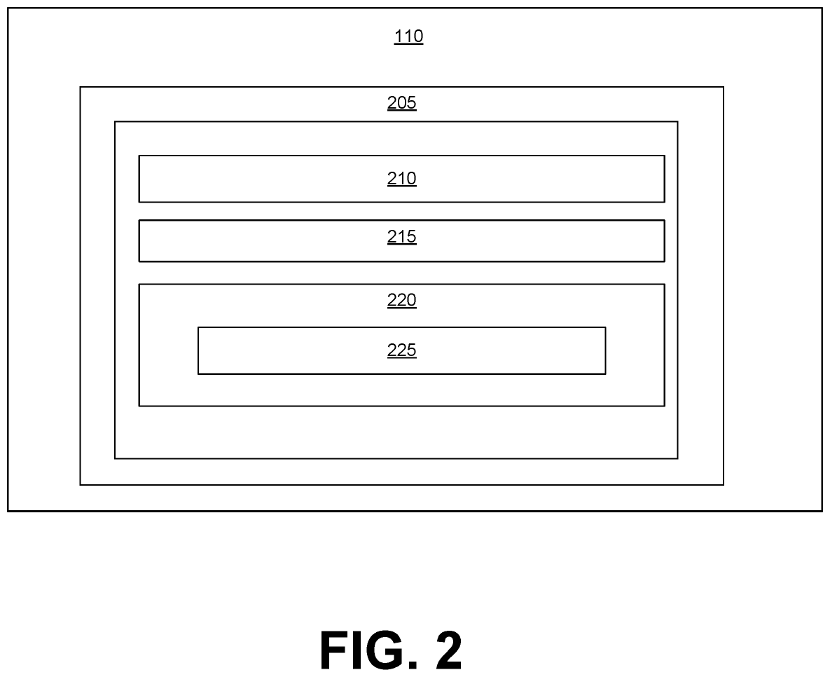

FIG. 2 illustrates an example computer 110 that includes a control system 205. As shown, the control system 205 includes a path planning module 210, an autonomous operation module 215, and an explicit Nonlinear Model Predictive Control (NMPC) module 220. The path planning module 205 is configured to obtain, store, and transmit or provide access to a planned trajectory for the vehicle 105. The autonomous operation module 210 is configured to perform operations of the vehicle 105 such that the vehicle 105 follows the planned trajectory. For example, the autonomous operation module 210 can generate and transmit commands that are transmitted to the actuators 120.

During operation, the computer 110 can implement an explicit Nonlinear Model Predictive Control (NMPC) module 220. For instance, the computer 110 receives sensor data and/or control data, e.g., one or more control inputs, a planned trajectory, a system model, etc., for the vehicle 105, and then provides the control data as input values to the explicit NMPC module 220. The explicit NMPC module 220 can generate control data to control one or more actuators 120. For example, the explicit NMPC module 220 constrained brake input commands and/or propulsion torque commands to control operation of the wheels.

The explicit NMPC module 220 also receives sensor data from the one or more sensors 115. For example, the sensor data can include, but is not limited to, data indicative of axle velocities, road steering wheel angle, road steering angular rate, track, and/or wheelbase. As discussed herein, the explicit NMPC module 220 can generate one or more commands to control one or more actuators 120 within the vehicle 105. For example, the explicit NMPC module 220 can generate constrained brake input commands and/or propulsion torque commands, i.e., commands for controlling a front motor torque, a left front wheel brake torque, and/or a right front wheel brake torque.

During operation, the computer 110 can use the sensor data to determine a slip condition using suitable slip condition estimation processes. The slip condition represents a particular wheel behavior occurring due to a driving condition, i.e., relatively slick surface conditions due to rain and/or snow, normal surface conditions, and the like. In an example implementation, the slip condition can correspond to a long stable period, e.g., wheel is traversing an asphalt surface, a stable period, e.g., wheel is traversing a gravel surface, or a short stable period, e.g., wheel is traversing a snow-covered and/or ice-covered surface.

The computer 110 estimates the slip condition using the sensor data, e.g., the data representing axle velocities, road steering wheel angle, road steering angular rate, track, and/or wheelbase. For example, the computer 110 can estimate the slip condition according to V_{diff}=Vx_{LF}−Vx_{RF}, where V_{diff} comprises a calculated wheel velocity difference, Vx_{LF} comprises a velocity measurement for the left-front wheel, and Vx_{RF} comprises a velocity measurement for the right-front wheel as well as according to

$${V}_{avgf} = \frac{VxLF - VxRF}{2} ,$$

where V_{avgf} comprises a calculated average wheel velocity.

The explicit NMPC module 220 includes a feedforward control module 225 to generate adjustment data. The adjustment data can be used by one or more components of the explicit NMPC module 220 to modify the control data prior to the control data being transmitted to the actuators 120. The feedforward control module 225 receives the determined slip condition from the computer 110 and outputs adjustment corresponding to the determined slip condition, e.g., stability period. In various implementations, the feedforward control module 225 can include a lookup table that relates estimated, e.g., determined, slip condition to adjustment data. It is understood that in some implementations, the feedforward control module 225 accounts for differences in slip conditions between wheels, e.g., left-front wheels and right-front wheels. The feedforward control module 225 can include one or more gain calculations that are applied to the adjustment data.

The adjustment data can be used to modify control data generated by other components within the explicit NMPC module 220. For example, the adjustment data can comprise constrained brake input command adjustments and/or propulsion torque command adjustments that are used by the explicit NMPC module 220 to modify the brake input commands and/or propulsion torque commands, which are then provided to one or more actuators 120 to control the wheels accordingly.

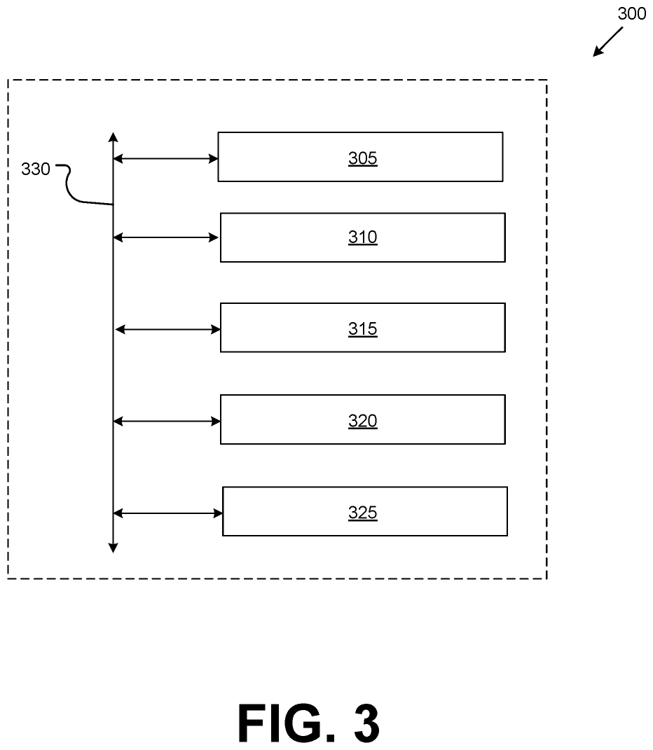

FIG. 3 illustrates an example computing device 300 i.e., computer 110 and/or server(s) 145 that may be configured to perform one or more of the processes described herein. As shown, the computing device can comprise a processor 305, memory 310, a storage device 315, an I/O interface 320, and a communication interface 325. Furthermore, the computing device 300 can include an input device such as a touchscreen, mouse, keyboard, etc. In certain implementations, the computing device 300 can include fewer or more components than those shown in FIG. 3.

In particular implementations, processor(s) 305 includes hardware for executing instructions, such as those making up a computer program. As an example, and not by way of limitation, to execute instructions, processor(s) 305 may retrieve (or fetch) the instructions from an internal register, an internal cache, memory 310, or a storage device 315 and decode and execute them.

The computing device 300 includes memory 310, which is coupled to the processor(s) 305. The memory 310 may be used for storing data, metadata, and programs for execution by the processor(s). The memory 310 may include one or more of volatile and non-volatile memories, such as Random-Access Memory (“RAM”), Read Only Memory (“ROM”), a solid-state disk (“SSD”), Flash, Phase Change Memory (“PCM”), or other types of data storage. The memory 310 may be internal or distributed memory.

The computing device 300 includes a storage device 315 includes storage for storing data or instructions. As an example, and not by way of limitation, storage device 315 can comprise a non-transitory storage medium described above. The storage device 315 may include a hard disk drive (HDD), flash memory, a Universal Serial Bus (USB) drive or a combination of these or other storage devices.

The computing device 300 also includes one or more input or output (“I/O”) devices/interfaces 320, which are provided to allow a user to provide input to (such as user strokes), receive output from, and otherwise transfer data to and from the computing device 300. These I/O devices/interfaces 320 may include a mouse, keypad or a keyboard, a touch screen, camera, optical scanner, network interface, modem, other known I/O devices or a combination of such I/O devices/interfaces 320. The touch screen may be activated with a writing device or a finger.

The I/O devices/interfaces 320 may include one or more devices for presenting output to a user, including, but not limited to, a graphics engine, a display (e.g., a display screen), one or more output drivers (e.g., display drivers), one or more audio speakers, and one or more audio drivers. In certain implementations, devices/interfaces 320 is configured to provide graphical data to a display for presentation to a user. The graphical data may be representative of one or more graphical user interfaces and/or any other graphical content as may serve a particular implementation.

The computing device 300 can further include a communication interface 325. The communication interface 325 can include hardware, software, or both. The communication interface 325 can provide one or more interfaces for communication (such as, for example, packet-based communication) between the computing device and one or more other computing devices 300 or one or more networks. As an example, and not by way of limitation, communication interface 325 may include a network interface controller (NIC) or network adapter for communicating with an Ethernet or other wire-based network or a wireless NIC (WNIC) or wireless adapter for communicating with a wireless network, such as a WI-FI. The computing device 300 can further include a bus 330. The bus 330 can comprise hardware, software, or both that couples components of computing device 300 to each other.

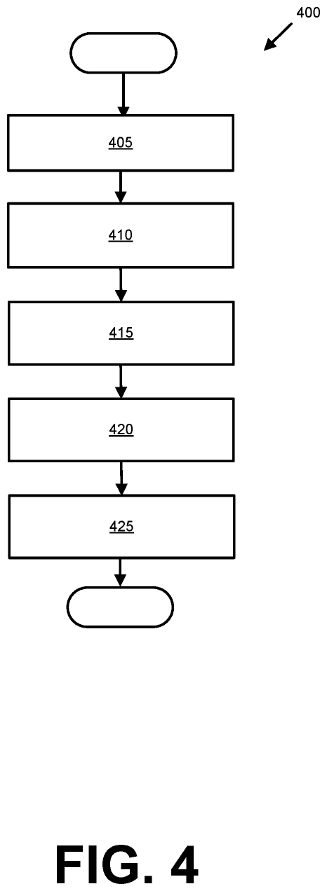

FIG. 4 illustrates an example process 400 for generating adjustment data within the explicit NMPC module 220 via a feedforward control module 225. Blocks of the process 400 can be executed by the computer 110. At block 405, sensor data is received from one or more vehicle sensors 115. For example, the sensor data can comprise data indicative of axle velocities, road steering wheel angle, road steering angular rate, track, and/or wheelbase.

At block 410, the slip condition for one or more wheels is estimated. As discussed above, the slip condition can correspond to a particular wheel behavior occurring within a driving condition. At block 415, the feedforward control module 225 generates adjustment data based on the estimated slip condition. At block 420, the explicit NMPC module 220 generates control data based on data received from one or more observers and/or the adjustment data. At block 425, the control data is transmitted to the actuators 120 to cause the wheels to operate accordingly. In other words, the control data can be used to control one or more aspects of the traction control system component. The process 400 then ends.

The description of the present disclosure is merely exemplary in nature and variations that do not depart from the gist of the present disclosure are intended to be within the scope of the present disclosure. Such variations are not to be regarded as a departure from the spirit and scope of the present disclosure.

In general, the computing systems and/or devices described may employ any of a number of computer operating systems, including, but by no means limited to, versions and/or varieties of the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory may include a computer readable medium (also referred to as a processor readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain implementations, and should in no way be construed so as to limit the claims.

Accordingly, it is to be understood that the above description is intended to be illustrative and not restrictive. Many implementations and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future implementations. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system comprising a computer including a processor and a memory, the memory including instructions such that the processor is programmed to:
estimate a slip condition corresponding to at least one vehicle wheel; and
generate, via an explicit Nonlinear Model Predictive Control (NMPC) module, control data for operating the at least one vehicle wheel based on the estimated slip condition,
wherein the explicit Nonlinear Model Predictive Control (NMPC) module includes a feedforward control module that is configured to generate adjustment data based on the estimated slip condition, wherein the adjustment data modifies the control data.

2. The system of claim 1, wherein the processor is further programmed to estimate the slip condition based on sensor data.

3. The system of claim 2, wherein the sensor data comprises data indicative of at least one of an axle velocity, a road steering wheel angle, a road steering angular rate, a track corresponding to the at least one vehicle wheel, or a wheelbase corresponding to the at least one vehicle wheel.

4. The system of claim 3, wherein the processor is further programmed to receive the sensor data from at least one vehicle sensor.

5. The system of claim 1, wherein the control data comprises data representing at least one of a constrained brake input command or a propulsion torque command.

6. The system of claim 5, wherein the processor is further programmed to transmit the control data to an actuator to control at least one of a left front wheel brake torque, or a right front wheel brake torque.

7. The system of claim 1, wherein the slip condition represents a particular wheel behavior occurring due to a driving condition.

8. The system of claim 7, wherein the slip condition corresponds to at least one of a long stable period, a stable period, or a short stable period.

9. The system of claim 8, wherein the processor is further programmed to access a lookup table that relates the estimated slip condition to the adjustment data.

10. The system of claim 1, wherein the feedforward control module includes the lookup table.

11. A method comprising:
estimating a slip condition corresponding to at least one vehicle wheel; and
generating, via an explicit Nonlinear Model Predictive Control (NMPC) module, control data for operating the at least one vehicle wheel based on the estimated slip condition,
wherein the explicit Nonlinear Model Predictive Control (NMPC) module includes a feedforward control module that is configured to generate adjustment data based on the estimated slip condition, wherein the adjustment data modifies the control data.

12. The method of claim 11, the method further comprising estimating the slip condition based on sensor data.

13. The method of claim 12, wherein the sensor data comprises data indicative of at least one of an axle velocity, a road steering wheel angle, a road steering angular rate, a track corresponding to the at least one vehicle wheel, or a wheelbase corresponding to the at least one vehicle wheel.

14. The method of claim 13, the method further comprising receiving the sensor data from at least one vehicle sensor.

15. The method of claim 11, wherein the control data comprises data representing at least one of a constrained brake input command or a propulsion torque command.

16. The method of claim 15, the method further comprising transmitting the control data to an actuator to control at least one of a left front wheel brake torque, or a right front wheel brake torque.

17. The method of claim 11, wherein the slip condition represents a particular wheel behavior occurring due to a driving condition.

18. The method of claim 17, wherein the slip condition corresponds to at least one of a long stable period, a stable period, or a short stable period.

19. The method of claim 18, the method further comprising accessing a lookup table that relates the estimated slip condition to the adjustment data.

20. The method of claim 11, wherein the feedforward control module includes the lookup table.
